(19) United States
(12) Patent Application Publication
(10) Pub. No.: US 2015/0019718 A1
(43) Pub. Date: Jan. 15, 2015

(54) METHOD FOR SERVICE DISCOVERY IN WIRELESS PERSONAL AREA NETWORK

(71) Applicant: Electronics and Telecommunications Research Institute, Daejeon (KR)

(72) Inventors: Wun Cheol JEONG, Daejeon (KR); Tae Joon PARK, Daejeon (KR); Chang Sub SHIN, Daejeon (KR); Ho Yong KANG, Daejeon (KR); Cheol Sig PYO, Daejeon (KR)

(21) Appl. No.: 14/329,030

(22) Filed: Jul. 11, 2014

(30) Foreign Application Priority Data
Jul. 12, 2013 (KR) 10-2013-0081947
Jul. 8, 2014 (KR) 10-2014-0085086

(51) Int. Cl. H04L 29/12

(52) U.S. Cl. CPC H04L 61/1541
USPC 709/224

(57) ABSTRACT

Disclosed are methods for service discovery in a wireless personal area communication network. A method for service discovery, performed in a terminal, the method comprises performing a passive scan for searching a specific service based on whether to receive a frame including a specific service identifier; and, when it fails to search the specific service, performing an active scan which broadcasts a service discovery request command frame for searching the specific service. Thus, service discovery may be efficiently performed by reducing the operation complexity of the terminal and minimizing the power consumption of the terminal needed for service discovery, without support of a upper layer.

### CLAIM FOR PRIORITY

This application claims priorities to Korean Patent Application No. 10-2013-0081947 filed on Jul. 12, 2013, and No. 10-2014-0085086 filed on Jul. 8, 2014 in the Korean Intellectual Property Office (KIPO), the entire contents of which are hereby incorporated by references.

### BACKGROUND

1. Technical Field

Example embodiments of the present invention relate to a wireless personal area networking technology, and more specifically to methods for service discovery in a wireless personal area network which can minimize power consumption.

2. Related Art

According to diversification of a personal wireless communication market, a demand of simultaneously using various application services in the same wireless personal area network (WPAN) is currently increasing. Therefore, operators providing communication terminals and organizations standardizing communication specifications are trying to provide services satisfying different requirements by using multiple radio interfaces.

However, in the above-described network environment, in order for a terminal to use a specific desired service, the terminal should identify whether the specific service is provided by the network and whether the specific service is currently being used.

In the conventional wireless personal area network, a physical layer and a Medium Access Medium (MAC) layer are defined in order to provide a specific service domain. Through these, a scanning function used for network discovery is provided in order for a terminal to access a network providing a corresponding service.

However, such the network scanning function is restricted to a function to identify only whether a specific wireless network indicated by a network operation exists or not. Thus, there is a problem that it cannot be applied to a wireless communication system which tries to provide various services through various frequency bands.

Also, even though the specific service is discovered, if a communication terminal does not know actual operating radio channel frequency bands which are currently provided by a network, a problem that wireless communications cannot be actually performed may occur.

Thus, demanded are methods for a terminal to efficiently discover services and operating frequency channels in a wireless personal area communication network providing multiple services through multiple frequency bands or radio channels.

### SUMMARY

Accordingly, example embodiments of the present invention are provided to substantially obviate one or more problems due to limitations and disadvantages of the related art.

Example embodiments of the present invention provide methods for service discovery, which can identify whether a desired service exists or not and operating radio frequency channels of the desired service in a transport layer without supports of a upper layer, and search for the desired service with minimized power consumption, in a wireless personal area communication network environment providing multiple services over multiple frequency bands (channels).

In some example embodiments of the present invention, a method for identifying whether a desired service exists and searching operating radio frequency channels in a transport layer (a physical layer and a MAC layer) without support of a higher layer is provided.

In the present invention, each terminal transmits a service discovery request frame with the same long interval. Thus, a procedure for temporal synchronization between terminals may be omitted so that system complexity may be reduced.

Also, the present invention provides a CSMA-CA algorithm optimized for service discovery in a network where many terminals exist, and so reduces service discovery delay times due to retransmissions of command frames.

Also, a channel sampling procedure is performed by a terminal which searched a desired service so that service discovery of other terminals may be made possible with minimizing power consumption of the terminal.

Also, the reduction of service discovery delay time and the reduction of power consumption according to the channel sampling procedure may maximize the battery lifetime of the terminal and the life time of the network.

Also, in the present invention, service discovery may be efficiently performed by reducing the operation complexity of the terminal and minimizing the power consumption of the terminal needed for service discovery.

### BRIEF DESCRIPTION OF DRAWINGS

Example embodiments of the present invention will become more apparent by describing in detail example embodiments of the present invention with reference to the accompanying drawings, in which:

FIG. 1 is a state transition diagram of a MAC layer for low energy service discovery;

FIG. 2 is a message sequence chart explaining a passive LESD scanning procedure illustrated in FIG. 1;

FIG. 3 is a message sequence chart explaining an active LESD scanning procedure illustrated in FIG. 1;

FIG. 4 is a message sequence chart explaining a channel sampling procedure illustrated in FIG. 1;

FIG. 5 is a conceptual diagram explaining the channel sampling procedure;

FIG. 6 illustrates a format of a LESD request command frame;

FIG. 7 illustrates a format of a LESD response command frame;

FIG. 8 illustrates a format of a LESD notification command frame;

FIG. 9A illustrates a structure of a MLSDE-LESD-SCAN.request primitive;

FIG. 9B illustrates parameters of the MLSDE-LESD-SCAN.request primitive;

FIG. 10A illustrates a structure of a MLSDE-LESD-SCAN.confirm primitive;

FIG. 10B illustrates parameters of the MLSDE-LESD-SCAN.confirm primitive;

FIG. 11A illustrates a structure of a MLSDE-LESD.request primitive;

FIG. 11B illustrates parameters of the MLSDE-LESD.request primitive;

FIG. 12A illustrates a structure of a MLSDE-LESD.indication primitive;

FIG. 12B illustrates parameters of the MLSDE-LESD.indication primitive;

FIG. 13A illustrates a structure of a MLSDE-LESD.response primitive;

FIG. 13B illustrates parameters of the MLSDE-LESD.response primitive;

FIG. 14A illustrates a structure of a MLSDE-LESD.confirm primitive;

FIG. 14B illustrates parameters of the MLSDE-LESD.confirm primitive;

FIG. 15A illustrates a structure of a MLSDE-LESD-NOTIFY.indication primitive;

FIG. 15B illustrates parameters of the MLSDE-LESD-NOTIFY.indication primitive;

FIG. 16A illustrates a structure of a MLSDE-LESD-CS.request primitive;

FIG. 16B illustrates parameters of the MLSDE-LESD-CS.request primitive;

FIG. 17A illustrates a structure of a MLSDE-LESD-CS.confirm primitive;

FIG. 17B illustrates parameters of the MLSDE-LESD-CS.confirm primitive;

FIG. 18 is a flow chart illustrating a serial CSMA-CA procedure for Low Energy Service Discovery;

FIG. 19 is a flow chart illustrating a parallel CSMA-CA procedure for Low Energy Service Discovery;

FIG. 20 is a flow chart illustrating a backoff count procedure performed in a parallel CSMA-CA procedure illustrated in FIG. 19;

FIG. 21 illustrates a structure of a physical layer frame;

FIG. 22 illustrates an example of a SFD used in the LESD;

FIG. 23A and FIG. 23B illustrate physical layer headers.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. To aid in understanding the present invention, like numbers refer to like elements throughout the description of the drawings, and the description of the same element will not be reiterated.

Contents which are not explained specifically in the following example embodiments of the present invention may be supported by standard specifications (for example, IEEE 802.15) provided from organizations progressing standardization on wireless personal area network technologies.

The terminologies which are used in the present specification are defined as follows.

CS: Channel Sampling

BRB: Basic Repetition Block

LESD: Low Energy Service Discovery

LIFS: Long Inter Frame Spacing

MAC: Medium Access Control

MHR: MAC Header

MLME: MAC sublayer Management Entity

MLSDE: MAC sublayer Service Discovery Entity

PAC: Peer Aware Communication

PAN: Personal Area Network

PD: PAC Device

PLME: PHY layer Management Entity

SFD: Start frame delimiter

PIB: PAN information base

WPAN: Wireless Personal Area Network

Service discovery methods according to the present invention may provide Medium Access Control layer (MAC layer) technologies and Physical layer (PHY layer) technologies for low energy service discovery (hereinafter, referred to as ‘LESD’).

First, the MAC layer technologies for LESD will be explained.

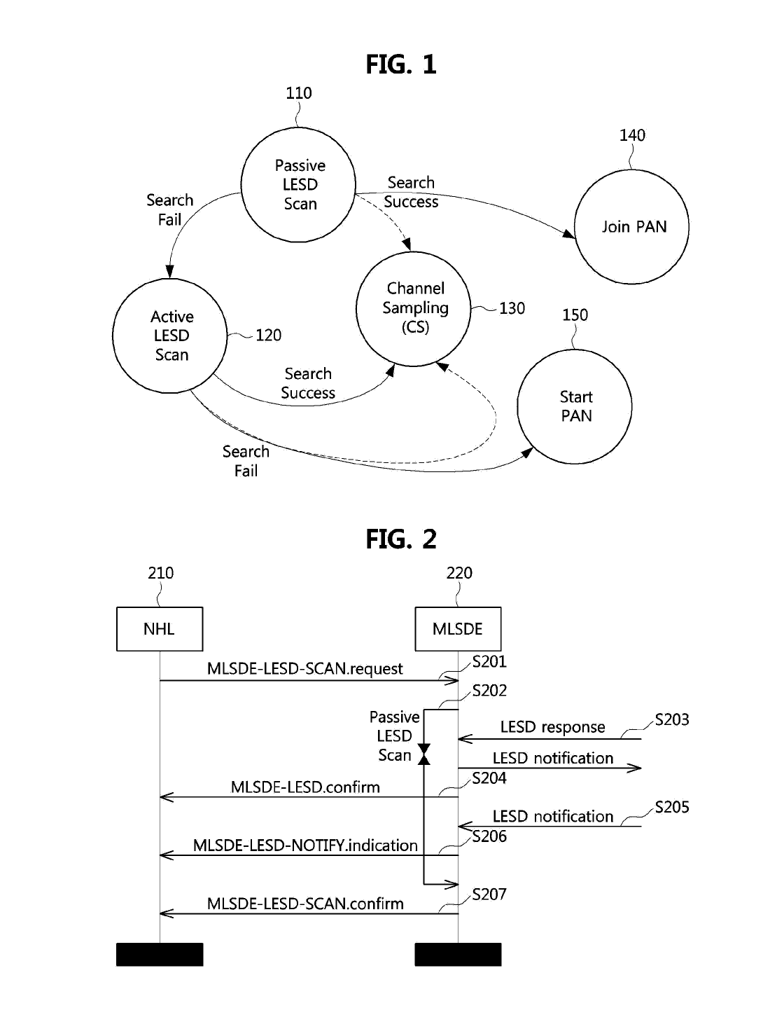

FIG. 1 is a state transition diagram of a MAC layer for low energy service discovery. Also, FIG. 2 is a message sequence chart explaining a passive LESD scanning procedure illustrated in FIG. 1.

Hereinafter, a passive LESD scanning procedure will be explained by referring to FIG. 1 ad FIG. 2.

Passive LESD Scanning Procedure (110)

For LESD, a terminal (PD: Peer-aware communication device) whose macLESDenbaled value is set to TRUE may perform a passive LESD scanning procedure based on a MLSDE-LESD-SCAN.request primitive.

A Next Higher Layer (NHL) 210 which is a higher layer of a MAC layer generates the MLSDE-LESD-SCAN.request primitive and transmits the generated primitive to a MAC sublayer Service Discovery Entity (MLSDE) 220 in order to perform the passive scan on a physical channel configured with LESDChannelID for identifying whether a service corresponding to a ServiceID exists or not (S201).

On the receipt of the MLSDE-LESD-SCAN.request primitive from the NHL 210, the MLSDE 220 of the terminal updates macServiceID which is an attribute of MAC PAN Information Base (PIB) with the ServiceID parameter of the MLSDE-LESD-SCAN.request primitive, updates macAvailableChannelID with an AvailableChannelID parameter of the MLSDE-LESD-SCAN.request primitive, and performs the passive LESD scan (S202).

If a frame is received while performing the passive LESD scan, a physical layer checks whether the received frame is a LESD response command frame or a LESD notification command frame based on a Start Frame Delimiter (SFD) field of the received frame. If the received frame is not one of the command frames, the physical layer does not proceed further decoding and discard the received frame.

If the physical layer receives a command frame (a LESD response command frame or a LESD notification command frame) including a valid SFD and transmits the received command frame to the MLSDE 220, the MLSDE 220 checks whether a ServiceID field of the received frame matches the macServiceID. In this case, the received frame is discarded when the ServiceID field of the received frame does not match the macServiceID. Otherwise, the MLSDE 220 notifies the higher layer 210 of the receipt of the command frame by using a primitive corresponding to the type of the received command frame.

That is, when the received frame is the LESD response command frame (S203), the MLSDE 220 reports it to the higher layer 210 by using a MLSDE-LESD.confirm primitive (S204). Also, when the received frame is the LESD notification command frame (S205), the MLSDE 220 reports it to the higher layer 210 by using a MLSDE-LESD-NOTIFY.indication primitive (S206).

Meanwhile, the terminal performs the passive LESD scan procedure 110 for at most macNumBRB×T_{BRB} (S202). Here, T_{BRB} is a time needed for receiving a single Basic Repetition Block (BRB), and macNumBRB is an attribute value indicating the number of repeated BRBs. Here, a BRB may comprise a synchronization header (SHR) and a physical layer header (PHR) of a physical layer frame, and a SHR may comprise a preamble and a Start Frame Delimiter (SFD).

If the passive LESD scan is completed, the MLSDE 220 of the terminal transmits the scan result to the higher layer 210 by using a MLSDE-LESD-SCAN.confirm primitive (S207).

If the terminal succeeds in finding a desired Peer-Aware Communication (PAC) service and a physical channel used by the service through the above-described passive scan, the higher layer of the terminal can access a corresponding Personal Area Network (PAN) providing the found service by generating a MLME-ASSOCIATE primitive (that is, a PAN joining state 140 of FIG. 1). While the terminal is trying to access the corresponding PAN, the MLSDE is instructed to enter into a channeling sampling (CS) state 130 by the higher layer via a MLSDE-LESD-CS.request primitive.

Otherwise, the terminal does not find the desired PAC service and the physical channel used by the service, the terminal goes to an active LESD scan state 120 and continues service discovery.

Active LESD Scanning Procedure (120)

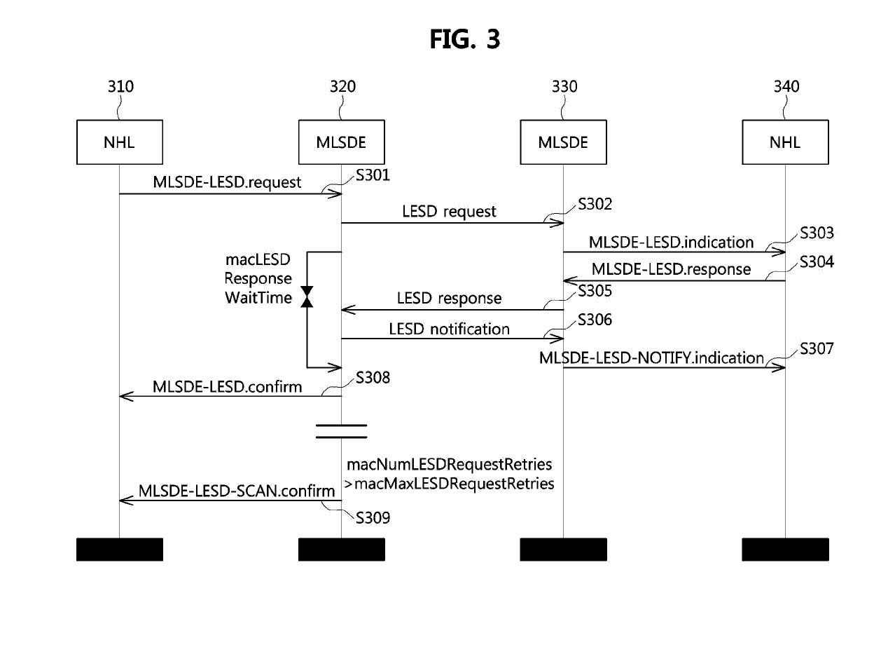

FIG. 3 is a message sequence chart explaining an active LESD scanning procedure illustrated in FIG. 1.

Hereinafter, an active LESD scanning procedure will be explained by referring to FIG. 1 ad FIG. 3.

If the terminal fails to find the desired PAC service through the passive LESD scanning procedure 110, it tries to find the desired service by performing the active LESD scanning procedure.

The NHL 310 makes the active LESD scanning procedure initiated by issuing a MLSDE-LESD.request primitive to the MLSDE 320 (S301).

On the receipt of the MLSDE-LESD.request primitive, the MLSDE 320 generates a LESD request command, and broadcasts the LESD request command via Carrier Sense Multiple Access-Collision Avoidance (CSMA-CA) algorithm which will be explained later (S302).

A MLSDE 330 of a neighbor terminal which receives the broadcasted LESD request command checks whether a ServiceID field of the received command frame matches macServiceID. If the ServiceID field of the received command frame does not match the macServiceID, the MLSDE 330 discards the received command frame.

Otherwise, if the ServiceID field of the received command frame matches the macServiceID, it may reports to the higher layer 340 that the LESD request command frame is received via a MLSDE-LESD.indication primitive (S303).

When the higher layer 340 of the neighbor terminal receives the MLSDE-LESD.indication primitive, it may transmit a MLSDE-LESD.response primitive to the MLSDE 330 (S304).

When the MLSDE 330 of the terminal receives the MLSDE-LESD.response primitive from the higher layer 340, it generates a LESD response command frame, and broadcasts the generated command frame via CSMA-CA algorithm (S305).

The MLSDE 320 which receives the broadcasted LESD response command frame checks whether a ServiceID field of the received command frame matches the macServiceID. If the ServiceID field of the received command frame does not match the macServiceID, the MLSDE 320 discards the received command frame.

Otherwise, if the ServiceID field of the received command frame matches the macServiceID, the MLSDE 320 updates a value of macCommunicationChannelID with a CommunicationChannelID parameter of the received frame, and reports to the higher layer 310 that the LESD response command frame is received by using a MLSDE-LESD.confirm primitive (S308).

In addition, the MLSDE 320 generates a LESD notification command frame, and broadcasts the generated command frame via CSMA-CA algorithm (S306). Through the broadcasting, it can be again notified to neighbor terminals that the corresponding service exists.

The MLSDE 330 of the neighbor terminal which receives the LESD notification command frame checks whether a ServiceID field of the received command frame matches the macServiceID. If they coincide with each other, the MLSDE 330 updates a value of macCommunicationChannelID with a CommunicationChannelID parameter of the received command frame, and notifies to the higher layer 340 that the LESD notification command frame is received by using a MLSDE-LESD-NOTIFY.indication primitive (S307).

If the above descriptions are summarized, terminals wanting to find a same service may find the service by receiving a LESD response command frame or a LESD notification commands including the same service. Then, if the service is found, a LESD request command frame, which they are to transmit for finding the service, is not transmitted. This can reduce frame collisions due to unnecessary frame transmissions.

After broadcasting the LESD request command frame, if the MLSDE 320 does not receive a LESD response command frame or a LESD notification command frame including the desired service for a macLESDResponseWaitTime which is a maximum standby time, the MLSDE 320 increases macNumLESDRequestRetries which indicates the number of LESD request retransmissions by one. If the increased value does not exceed a macMaxLESDRequestRetries which indicates the maximum LESD request retransmission number, the MLSDE 320 may retransmit the LESD request command frame via CSMA-CA algorithm.

If the increased macNumLESDRequestRetries exceeds the macMaxLESDRequestRetries, the MLSDE 320 sets a Status parameter of a MLSDE-LESD-SCAN.confirm primitive to EXCEED_NUM_TRIAL, and notifies to the higher layer 310 that the active LESD scan is not successful by using the configured MLSDE-LESD-SCAN.confirm primitive (S309).

If the terminal fails to find a desired PAC service through the above-described active LESD scanning procedure, the higher layer can try to initiate a new PAN by issuing a MLME-START primitive (a PAN start state 150 of FIG. 1). Meanwhile, the MLSDE is instructed to change its state into the channel sampling (CS) state 130 by the higher layer through a MLSDE-LESD-CS.request primitive.

Channel Sampling Procedure (130)

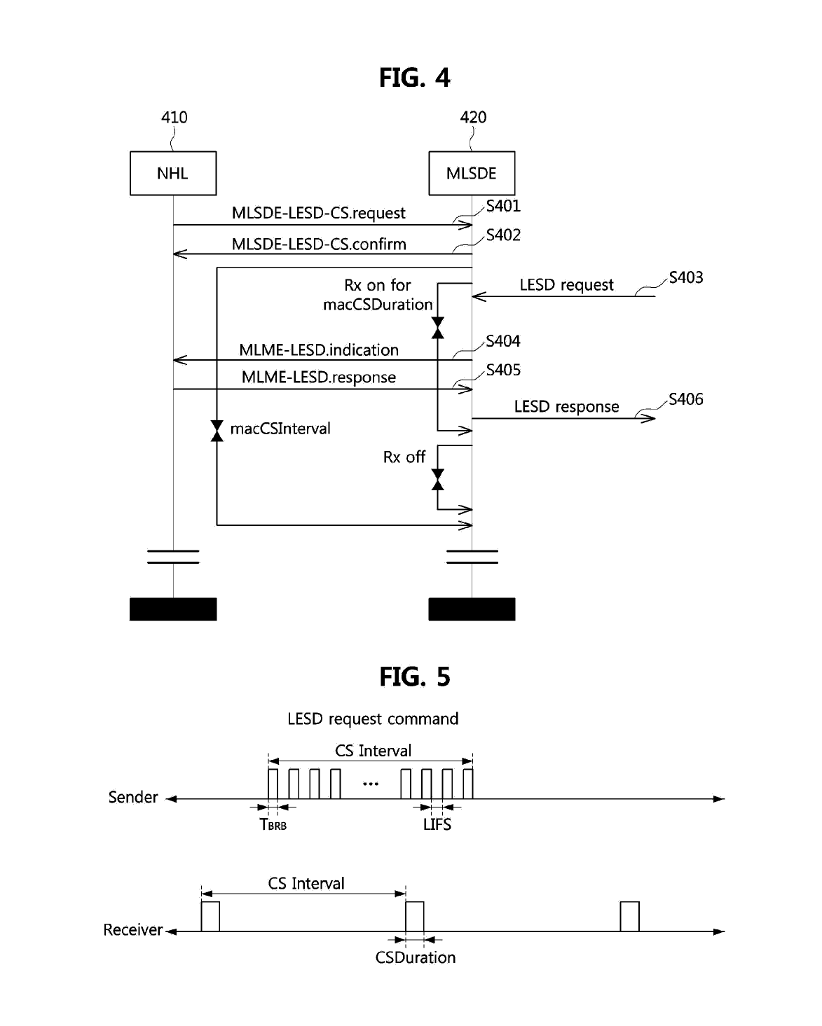

FIG. 4 is a message sequence chart explaining a channel sampling procedure illustrated in FIG. 1. Also, FIG. 5 is a conceptual diagram explaining the channel sampling procedure.

Hereinafter, a channel sampling procedure will be explained by referring to FIGS. 1, 4, and 5.

The channel sampling procedure can reduce power consumed in service discovery of a terminal.

A higher layer (NHL) 410 generates a MLSDE-LESD-CS.request primitive for channel sampling, and transmits the generated primitive to the MLSDE 420 (S401).

If the MLSDE 420 receives the MLSDE-LESD-CS.request primitive from the higher layer 410, the MLSDE 420 starts the channel sampling procedure. Also, the MLSDE 420 transmits a MLSDE-LESD-CS.confirm primitive to the higher layer 410 in response to the received MLSDE-LESD-CS.request primitive (S402).

On the receipt of the MLSDE-LESD-CS.request primitive, the MLSDE 420 sets a value of macLESDdone to TRUE, and updates values of macNumBRB and macCSDuration with a NumBRB parameter and a CSDuration parameter of the MLSDE-LESD-CS.request primitive. As shown in FIG. 5, the terminal may listen to channels for macCSDuration with a periodicity of a CS interval (macNumBRB×(T_{BRB}+T_{LIFS})). Here, the T_{LIFS} represents a Long Inter Frame Spacing (LIFS). The terminal waits for a LESD request command frame including a ServiceID field matching the macServiceID value to be received during macCSDuration. If such the LESD request command frame is not received during macCSDuration, the terminal turns off its receiver, and waits until the next CS interval.

Meanwhile, if the MLSDE 420 receives a LESD request command frame for the macCSDuration (S403), it checks whether a ServiceID field of the received command frame coincides with the macServiceID value. If they do not coincide, the MLSDE 420 discards the received command frame.

Otherwise, if the ServiceID field of the received command frame coincides with the macServiceID value, the MLSDE 420 reports to the higher layer 410 that the LESD request command frame is received via a MLSDE-LESD.indication primitive (S404).

On the receipt of the MLSDE-LESD.indication primitive, the higher layer 410 issues a MLSDE-LESD.response primitive to the MLSDE 420 in response to the MLSDE-LESD.indication primitive (S405).

If the MLSDE 420 receives the MLSDE-LESD.response primitive from the higher layer 410, it generates a LESD response command frame, and broadcasts the generated LESD response command frame via CSMA-CA algorithm (S406).

Hereinafter, MAC command frames according to the present invention will be explained in further detail.

LESD Request Command Frame

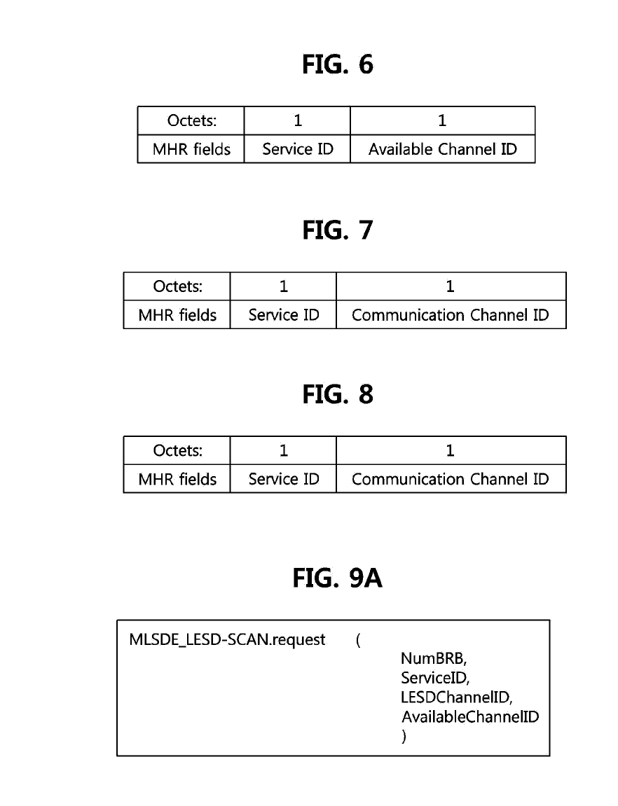

FIG. 6 illustrates a format of a LESD request command frame.

The LESD request command frame may be used for a terminal to request a neighbor terminal using a PAC service which the terminal wishes to search to reply information on whether the desired PAC service exists and used physical channel number.

The MHR of the LESD request command frame may include a ‘ServiceID’ field and an ‘AvailableChannelID’ field.

The ‘ServiceID’ field may be configured with 1 octet, and indicate the ID of PAC service which the terminal wishes to search. That is, the ‘Service ID’ field may have an identification number of the PAC service which the terminal wishes to search. The value of this filed is configured with the value of ServiceID parameter of MLSDE-LESD.request primitive received form a higher layer.

The ‘AvailableChannelID’ field may be configured with a set of octets, and indicate channel numbers of channels which the terminal can use. That is, the value of this field is configured with the value of AvailableChannelID parameter of MLSDE-LESD.request primitive received form a higher layer.

LESD Response Command Frame

FIG. 7 illustrates a format of a LESD response command frame.

The LESD response command frame may be used for a terminal to reply the result of the LESD request command.

The MHR of the LESD response command frame may include a ‘ServiceID’ field and a ‘CommunicationChannelID’ field.

The ‘ServiceID’ field may be configured with 1 octet, and indicate the ID of PAC service with which the terminal is associated. The value of this filed is configured with the value of ServiceID parameter of MLSDE-LESD.response primitive received form a higher layer.

The ‘CommunicationChannelID’ field may be configured with a set of octets, and indicate channel numbers of channels in use at the PAC WPAN with which the terminal is associated. That is, the value of this field is configured with the value of CommunicationChannelID parameter of MLSDE-LESD.response primitive received form a higher layer.

LESD Notification Command Frame

FIG. 8 illustrates a format of a LESD notification command frame.

The LESD notification command frame may be used for a terminal to announce the result of its service discovery to the neighbor terminals in response to the received LESD response command frame.

The MHR of the LESD notification command frame may include a ‘ServiceID’ field and a ‘CommunicationChannelID’ field.

The ‘Service ID’ field may be configured with 1 octet, and indicate the ID of PAC service which is being used. The value of this filed is configured with the value of ServiceID field of the received LESD response command frame.

The ‘CommunicationChannelID’ field may be configured with a set of octets, and indicate channel numbers of channels in use at the PAC WPAN with which the terminal is associated. That is, the value of this field is configured with the value of CommunicationChannelID field of the received LESD response command frame.

Hereinafter, MAC primitives according to the present invention will be explained in further detail.

MLSDE-LESD-SCAN.request Primitive

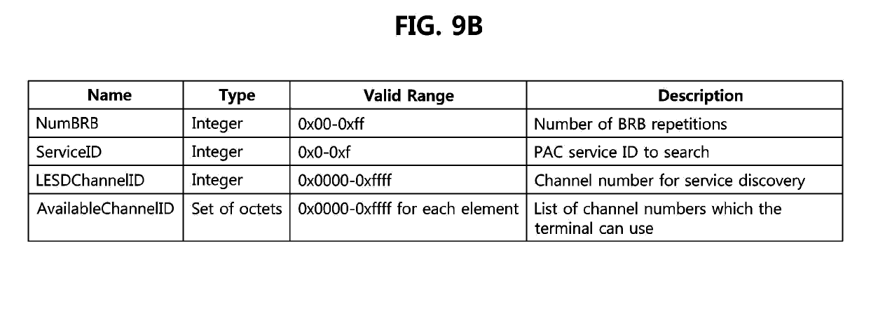

FIG. 9A illustrates a structure of a MLSDE-LESD-SCAN.request primitive, and FIG. 9B illustrates parameters of the MLSDE-LESD-SCAN.request primitive.

The MLSDE-LESD-SCAN.request primitive is generated by a higher layer, and transmitted to a MLSDE. This primitive is used for instructing to start a passive LESD scan to for PAC service discovery.

As shown in FIG. 9A and FIG. 9B, the MLSDE-LESD-SCAN.request primitive includes parameters such as NumBRB, ServiceID, LESDChannelID, and AvailableChannelID.

The NumBRB parameter indicates the number of BRB repetitions.

The ServiceID parameter indicates an ID of a PAC service which the terminal wishes to search.

The LESDChannelID parameter indicates a channel number used for service discovery.

The AvailableChannelID parameter indicates a list of channel numbers that the terminal can use.

When the MLSDE of the terminal receives the MLSDE-LESD-SCAN.request primitive from the higher layer, it respectively updates MAC PIB attributes macLESDChannelID, macServiceID, and macAvailableChannelID with parameters LESDChannelID, ServiceID, and AvailableChannelID of the MLSDE-LESD-SCAN.request primitive.

Then, the MLSDE performs the passive scan on a channel indicated by the macAvailableChannelID for at most macNumBRB×T_{BRB}. Here, T_{BRB} means a time needed for receiving a single BRB. After the scanning, the MLSDE reporting the scan result to the higher layer by using a MLSDE-LESD-SCAN.confirm primitive.

MLSDE-LESD-SCAN.confirm Primitive

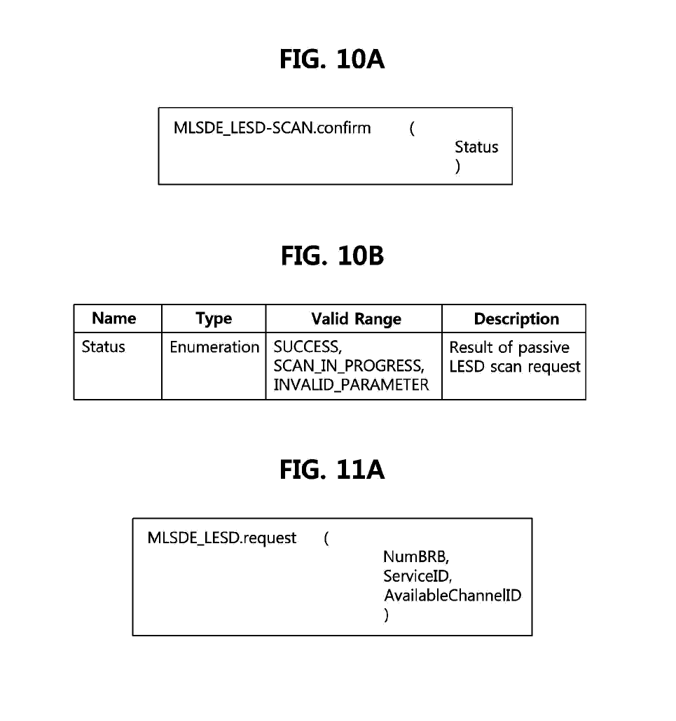

FIG. 10A illustrates a structure of a MLSDE-LESD-SCAN.confirm primitive, and FIG. 10B illustrates parameters of the MLSDE-LESD-SCAN.confirm primitive.

The MLSDE-LESD-SCAN.confirm primitive may be used for a MLSDE to report the to passive scan result to a higher layer.

As shown in FIG. 10A and FIG. 10B, the MLSDE-LESD-SCAN.confirm primitive may include a Status parameter.

The Status parameter indicates the result of the passive LESD scan request. According to the scan result, it may have one of SUCCESS, SCAN_IN-PROGRESS, INVALID_PARAMETER, NO_SERVIC_FOUND, etc.

While performing the passive LESD scan, if the MLSDE receives a LESD response command frame or a LESD notification command frame including a ServiceID parameter matching the macServiceID, the MLSDE generates the MLSDE-LESD-SCAN.confirm primitive including a corresponding Status parameter, and reports to the higher layer that the command frame is received. For example, if the LESD response command frame or the LESD notification command frame including the ServiceID parameter matching the macServiceID and a timer for the passive scan expires, the MLSDE sets the Status parameter to SUCCESS, and reports the completion of scan procedure to the higher layer via MLSDE-LESD-SCAN.confirm primitive.

Otherwise, if the LESD response command frame or the LESD notification command frame including the ServiceID parameter matching the macServiceID is not received until the timer for the passive scan expires, the MLSDE sets the Status parameter to NO_SERVICE FOUND, and reports the completion of scan procedure to the higher layer via MLSDE-LESD-SCAN.confirm primitive.

If the MLSDE receives the MLSDE-LESD-SCAN.request primitive from the higher layer while performing a previously initiated scan procedure, the MLSDE sets the Status parameter to SCAN_IN_PROGRESS, and reports to the higher layer that the previously initiated scan procedure is being performed via MLSDE-LESD-SCAN.confirm primitive.

MLSDE-LESD.request Primitive

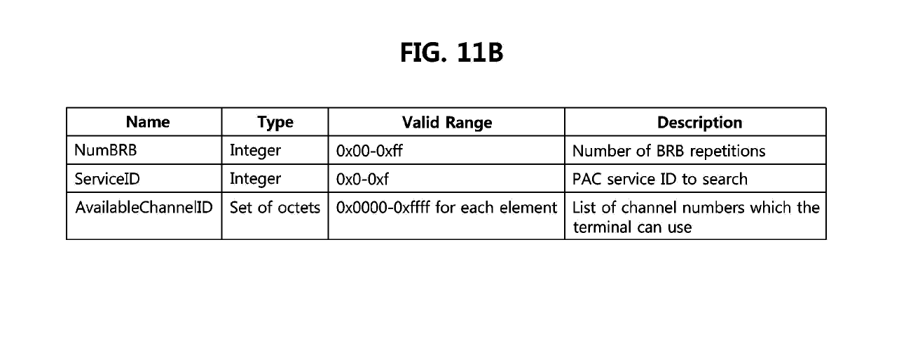

FIG. 11A illustrates a structure of a MLSDE-LESD.request primitive, and FIG. 11B illustrates parameters of the MLSDE-LESD.request primitive.

The MLSDE-LESD.request primitive may be used for a MLSDE to make a LESD request command for service discovery request.

The MLSDE-LESD.request primitive may include parameters NumBRB, ServiceID, and AvailableChannelID.

The NumBRB parameter indicates the number of BRB repetitions.

The ServiceID parameter indicates an ID of a PAC service which the terminal wishes to search.

The AvailableChannelID parameter indicates a list of channel numbers that the terminal can use.

The MLSDE-LESD.request primitive is generated by a higher layer, and transmitted to a MLSDE. This primitive is used for instructing the MLSDE to start an active LESD scan for PAC service discovery.

If the MLSDE receives the MLSDE-LESD.request primitive from the higher layer, it may updates MAC PIB attributes macServiceID and macAvailableChannelID with the values of ServiceID parameter and AvailableChannelID parameter respectively. Also, the MLSDE generates a LES request command frame, and broadcasts the command frame by using a CSMA-CA algorithm. Then, the MLSDE increases macMaxLESDRequestRetries by one, and set a timer for macLESDResponseWaitTime to wait for a LESD response command frame.

MLSDE-LESD.indication Primitive

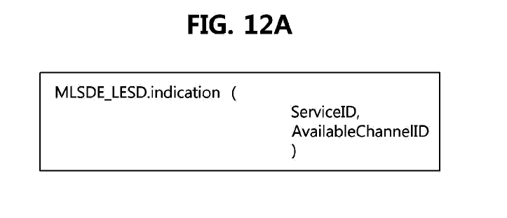

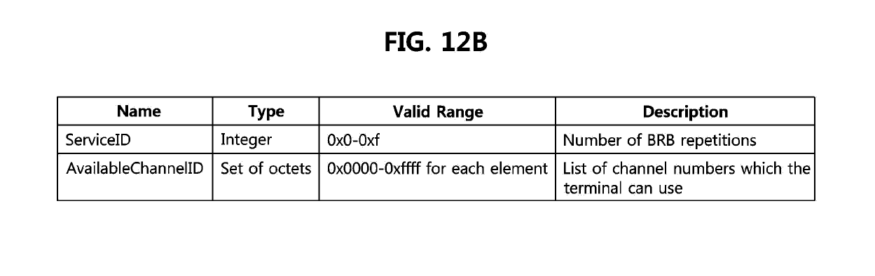

FIG. 12A illustrates a structure of a MLSDE-LESD.indication primitive, and FIG. 12B illustrates parameters of the MLSDE-LESD.indication primitive.

The MLSDE-LESD.indication primitive may be used to report the receipt of a LESD request command to a higher layer.

The MLSDE-LESD.indication primitive may include parameters ServiceID and AvailableChannelID.

The ServiceID parameter indicates an ID of a PAC service which the terminal wishes to search.

The AvailableChannelID parameter indicates a list of channel numbers that the terminal can use.

On the receipt of a LESD request command, the MLSDE checks the value of ServiceID field of the received command. If the value matches macServiceID of the terminal, the MLSDE generates MLSDE-LESD.indication primitive and notify the receipt of the command to the higher layer. If the value does not match the macServiceID of the terminal, the MLSDE discards the received command.

On receipt of the MLSDE-LESD.indication primitive, the higher layer instructs the MLSDE to generate a LESD response command via a MLSDE-LESD.response primitive.

MLSDE-LESD.response Primitive

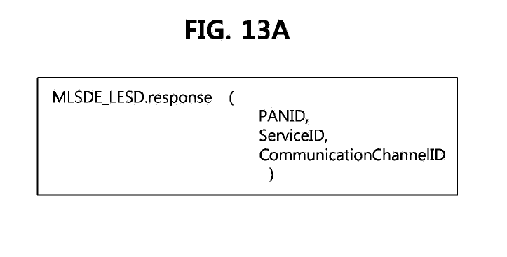

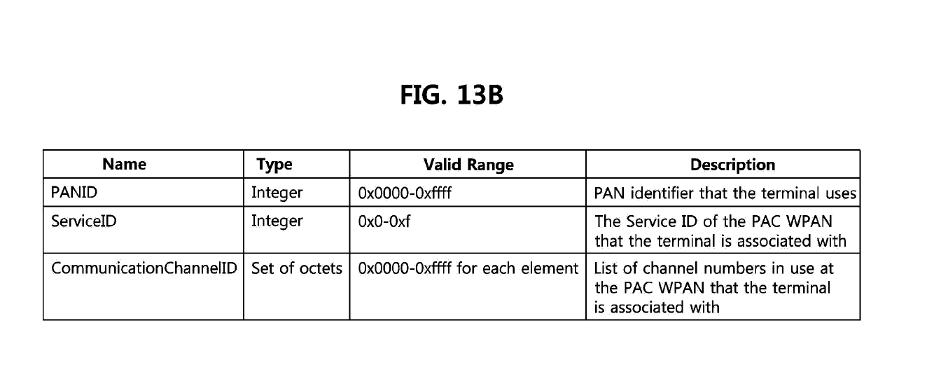

FIG. 13A illustrates a structure of a MLSDE-LESD.response primitive, and FIG. 13B illustrates parameters of the MLSDE-LESD.response primitive.

The MLSDE-LESD.response primitive may be used for a higher layer to respond to the MLSDE-LESD.indication primitive received from a terminal.

The MLSDE-LESD.response primitive may include parameters PANID, ServiceID, and CommunicationChannelID.

The PANID parameter indicates an identifier of a PAN used by the terminal.

The ServiceID parameter indicates the service ID of the PAC WPAN with which the terminal is associated.

The CommunicationChannelID parameter indicates channel number of channels in use at the PAC WPAN with which the terminal is associated.

The MLSDE-LESD.response primitive is generated by the higher layer and issued to its MLSDE.

On the receipt of the MLSDE-LESD.response primitive, the MLSDE update the MAC PIB attribute macCommunicationChannelID with the value of CommunicationChannelID parameter. Then, the MLSDE generates a LESD response command frame, and broadcasts the command to the neighbor terminals.

MLSDE-LESD.confirm Primitive

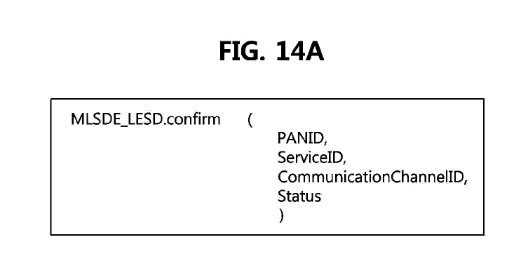

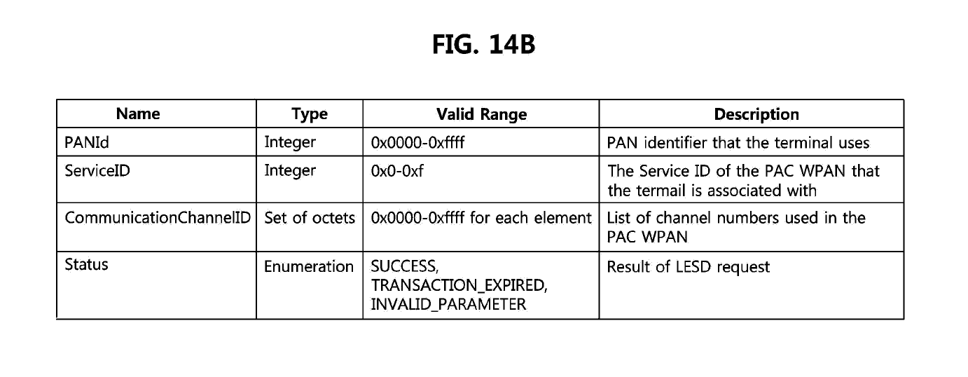

FIG. 14A illustrates a structure of a MLSDE-LESD.confirm primitive, and FIG. 14B illustrates parameters of the MLSDE-LESD.confirm primitive.

The MLSDE-LESD.confirm primitive may be used for a MLSDE to report the result of the LED request command to a higher layer.

The MLSDE-LESD.confirm primitive may include PANID, ServiceID, CommunicationChannelID, and Status.

The PANID parameter indicates an identifier of a PAN used by the terminal.

The ServiceID parameter indicates the service ID of the PAC WPAN with which the terminal is associated.

The CommunicationChannelID parameter indicates channel number of channels in use at the PAC WPAN with which the terminal is associated.

The Status parameter indicates the result of the LESD request command.

When the MLSDE receives a LESD response command from a MLSDE of a neighbor terminal, the MLSDE checks the value of ServiceID field of the received command. If the value matches to the macServiceID of the terminal, the MLSDE updates the MAC PIB attribute macCommunicationChannelID with the value of CommunicationChannelID field in the received command and generates a MLSDE-LESD.confirm primitive with the Status parameter of SUCCESS and report the results of the LESD request to the higher layer.

Then, the MLSDE generates a LESD notification command and broadcasts it to neighbor terminals. If the value of ServiceID field of the received LESD response command does not match to the macServiceID of the terminal, the MLSDE discard the received command.

The MLSDE of the terminal sets the value of Status field to TRANSACTION_EXPIRED and reports to the higher layer if the LESD response command with ServiceID field matching the macServiceID is not received for at most macLESDResponseWaitTime after the terminal transmits the LESD request command. The value of Status parameter is set to INVALID_PARAMETER otherwise.

MLSDE-LESD-NOTIFY.indication Primitive

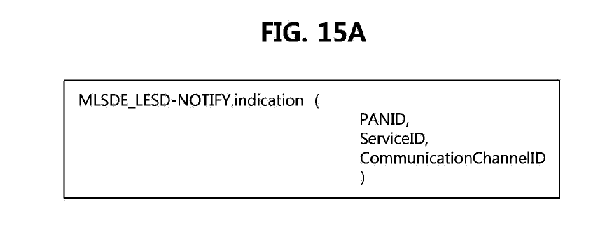

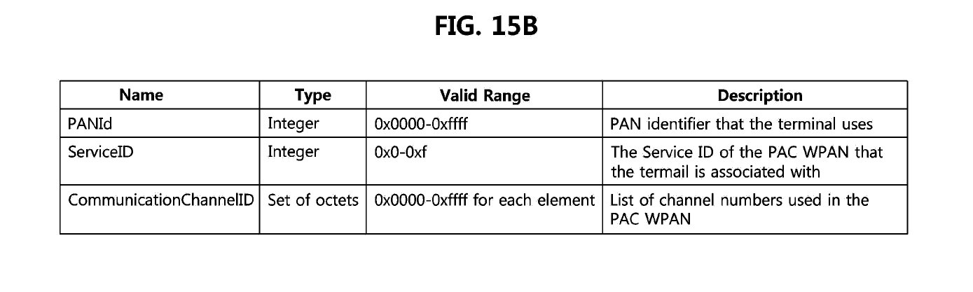

FIG. 15A illustrates a structure of a MLSDE-LESD-NOTIFY.indication primitive, and FIG. 15B illustrates parameters of the MLSDE-LESD-NOTIFY.indication primitive.

The MLSDE-LESD-NOTIFY indication primitive may be used for a MLSDE to report to a higher layer that a LES notification command frame is received.

The MLSDE-LESD-NOTIFY indication primitive may include parameters PANID, ServiceID, and CommunicationChannelID.

The PANID parameter indicates an identifier of a PAN used by the terminal.

The ServiceID parameter indicates the service ID of the PAC WPAN with which the terminal is associated.

The CommunicationChannelID parameter indicates channel number of channels in use at the PAC WPAN with which the terminal is associated.

This primitive is generated by the MLSDE and issued to its higher layer upon the reception of a LESD notification command frame with ServiceID field matching to macServiceID of the terminal. If the value of the ServiceID field of the LESD notification command does not match, MLSDE discard the received command.

On the receipt of the MLSDE-LESD-NOTIFY indication primitive, the higher layer is notified of the reception of a LESD notification command. The higher layer may be informed the PAC service and channel numbers in use among the terminals nearby. If the terminal is preparing a LESD request for the same PAC service, the terminal may not transmit the LESD request being prepared according to the receipt of the MLSDE-LESD-NOTIFY indication primitive.

MLSDE-LESD-CS.request Primitive

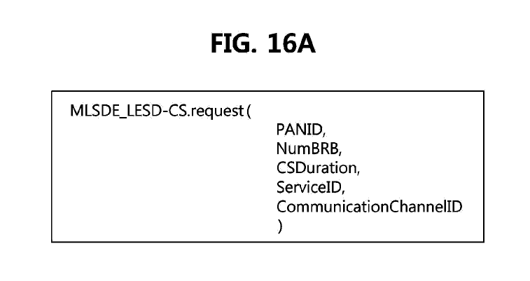

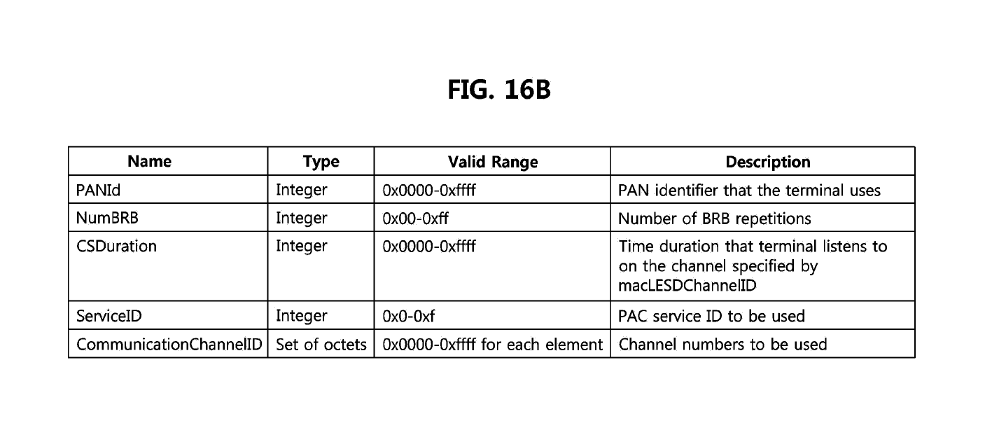

FIG. 16A illustrates a structure of a MLSDE-LESD-CS.request primitive, and FIG. 16B illustrates parameters of the MLSDE-LESD-CS.request primitive.

The MLSDE-LESD-CS.request primitive may be used for a MLSDE to initiate a CS procedure.

The MLSDE-LESD-CS.request primitive may include PANID, NumBRB, CSDuration, ServiceID, and CommunicationChannelID.

The PANID parameter indicates an identifier of a PAN used by the terminal.

The NumBRB parameter indicates the number of BRB repetitions. The time duration (NumBRB×(T_{BRB}+T_{LIFS})) indicates one time cycle in which the terminal samples the channel for T_{BRB} and sleeps for T_{LIFS} as illustrated in FIG. 5.

The CSDuration parameter indicates a time duration for which the terminal listens to a channel specified by macLESDChannelID.

The ServiceID parameter indicates an ID of a PAC service which the terminal wishes to search.

The CommunicationChannelID parameter indicates channel number of channels in use at the PAC WPAN with which the terminal is associated.

This primitive is generated by the higher layer when the terminal discovers the PAC service successfully or when the terminal does not discovery the service through passive and active LESD scan. If the terminal fails to discover the service through passive and active LESD scan, the corresponding service is regarded as unavailable. Thus, the terminal which performed the scan may newly initiate the corresponding service, and the terminal is supposed to enter into the CS procedure.

On the receipt of the primitive, the MLSDE updates the corresponding MAC PIB attributes. That is, the macLESDdone is set to TRUE, and macPANID, macNumBRB, macCSDuration, macServiceID, and macCommunicationChannelID are updated respectively with the parameters PANID, NumBRB, CSDuartion, ServiceID, and CommunicationChannelID.

MLSDE-LESD-CS.confirm Primitive

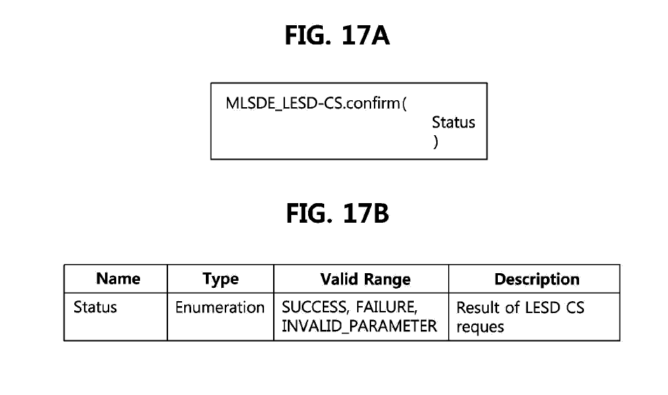

FIG. 17A illustrates a structure of a MLSDE-LESD-CS.confirm primitive, and FIG. 17B illustrates parameters of the MLSDE-LESD-CS.confirm primitive.

The MLSDE-LESD-CS.confirm primitive may be used for a MLSDE to report the result of a MLSDE-LESD-CS.request primitive to a higher layer.

The MLSDE-LESD-CS.confirm primitive may include a Status parameter.

The Status parameter indicates the result of the LESD CS request. According to the result, it may have one of SUCCESS, FAILURE, and INVALID_PARAMETER.

The MLSDE generates a MLSDE-LESD-CS.confirm primitive with the Status parameter of SUCCESS if it successfully updates the MAC PIB attributes with the values of corresponding parameters of MLSDE-LESD-CS.request primitive, and reports the result to the higher layer via the generated MLSDE-LESD-CS.confirm primitive.

If the MLSDE receives the MLSDE-LESD-CS.request primitive while performing other LESD MAC operation, the MLSDE may not perform the CS procedure and report the result to the higher layer via MLSDE-LESD-CS.confirm primitive with the status parameter of FAILURE. The value of Status parameter may be set to INVALID_PARAMETER otherwise.

Hereinafter, various methods for a terminal to transmit the above-described command frames will be explained.

A Back-Off Method for CSMA-CA

A terminal may access the channel by using a CSMA-CA algorithm when it tries to transmit the above-described command frames.

A serial CSMA-CA algorithm or a parallel CSMA-CA algorithm may be used as a channel access method of the terminal in consideration of a predicted discovery delay time, power consumption of the terminal, etc.

A Method for Frame Transmission Using a Serial CSMA-CA

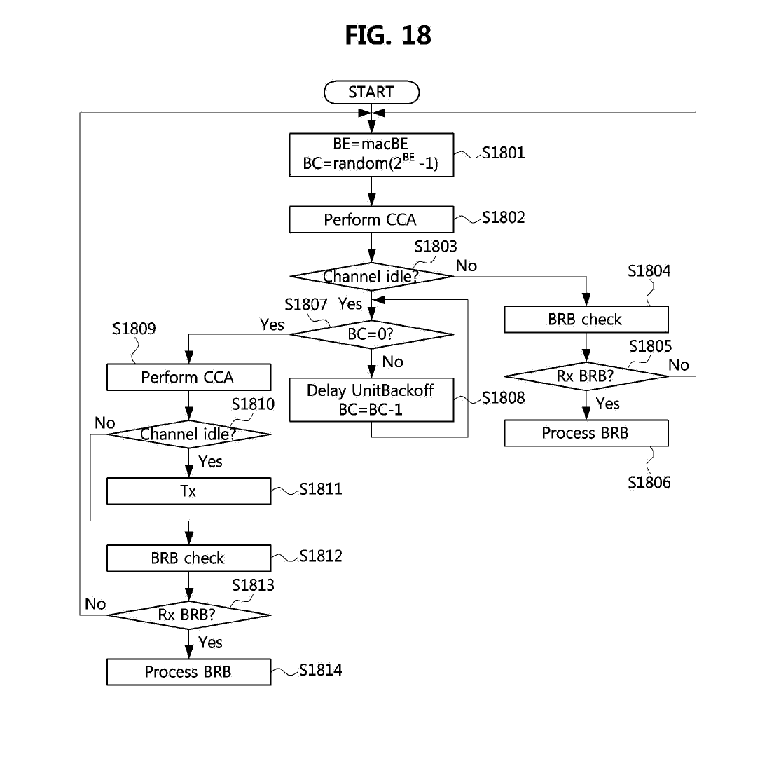

FIG. 18 is a flow chart illustrating a serial CSMA-CA procedure for Low Energy Service Discovery.

Referring to FIG. 18, a terminal may update a value of backoff exponent (BE) with the MAC PIB attribute macBE, and configure a value of backoff count (BC) by selecting an integer value among 0 to 2^{BE-1} with a uniform probability (S1801).

Then, the terminal changes its radio operation mode into a listening mode, and performs a clear channel assessment (CCA) procedure (S1802). The terminal may obtain channel samples on a symbol duration of predetermined bits (for example, 8 bits) in the CCA procedure, calculate an average value of the obtained channel samples, and compare the average value with a preconfigured threshold value (CCAThreshold) so as to determine a status of the channel (that is, busy or idle).

If the average value is greater than the threshold value, the terminal determines that the channel is in busy state. Otherwise, the terminal determines that the channel is in idle state (S1803).

If the channel is determined to be in busy state, the terminal performs a BRB check procedure for at most 2×T_{BRB}−T_{CCA} (S1804). Here, T_{BRB} is a time needed for transmitting a single BRB, and T_{CCA} is a time needed for performing the CCA. For example, T_{CCA} may be a time duration corresponding to 8 bits.

While the terminal is performing the BRB check procedure, the radio operation mode of the terminal is set to a listening mode. The terminal determines whether a BRB is received or not (S1805). If a BRB is received, the terminal performs a BRB handling procedure (S1806). Otherwise, if a BRB is not received during the above time duration, the terminal performs the CSMA-CA procedure again from the step S1801.

Otherwise, if the channel state is determined to be in idle state at the step S1803, the terminal turns off a receiver, and determines whether the value of BC is 0 (S1807).

In the step S1807, if the BC is not 0, the terminal decreases the BC by one, waits for a time of UnitBackOff (S1808), and repeats the procedure S1807 of determining whether the BC becomes 0. Here, the UnitBackOff means a time duration for which the terminal waits every time when the BC decreases by one.

If the BC becomes 0 through the above procedure, the terminal sets its radio operation mode to a listening mode, and performs the CCA procedure (S1809).

Then, the terminal checks the CCA result (S1810). If the channel is in idle state, the terminal sets its radio operation mode to a transmission mode, and transmits a frame in standby state (for example, LESD request, LESD response, and LESD notification) via the channel (S1811).

Otherwise, if the channel is in busy state, the terminal performs a BRB check procedure during at most 2×T_{BRB}−T_{CCA} (S1812). While performing the BRB check procedure, the radio operation mode is set to a listening mode.

The terminal checks whether a BRB is received during the above time duration (S1813). If a BRB is received, the terminal performs a BRB handling procedure (S1814). Otherwise, if a BRB is not received during the above time duration, the terminal performs the CSMA-CA procedure again from the step S1801.

Hereinafter, the BRB check procedure performed in the steps S1804 and S1812 of FIG. 18 will be explained in further detail.

If the BRB check procedure is initiated, the terminal operates in the listening mode. In the BRB check procedure, the terminal performs a preamble detection through the channel for at most 2×T_{BRB}−T_{CCA}. If a preamble is detected during the above period, the terminal performs a frame synchronization using the detected preamble, and receives SDF and PHR of the BRB. If the PHR is received, the terminal determines that the BRB is received successfully, and the physical layer reports the receipt of the BRB to the MAC layer.

Hereinafter, the BRB handling procedure performed in the steps S1806 and S1814 of FIG. 18 will be explained in further detail.

When it is identified that the BRB is received successfully through the BRB check procedure, the terminal may perform follow-up processes on the received BRB.

The physical layer of the terminal performs a temporal synchronization on the received frame by using the preamble, and identifies the type of the received frame by using first 8 bits-symbol in the SIT) of the received frame. Then, the physical layer of the terminal performs processes on the received frame according to the type of frame waiting in a queue and the type of the received frame as follows.

1) A Case when the Type of Received Frame is a LESD Request Command Frame.

If the type of the received frame is a LESD request command frame, it is checked whether first 2 bits symbol of the PHR is 0b11. If the value is 0b11, the following 6 bits (BRBcount) indicates the number of BRB repetitions after the received BRB. After then, the terminal turns off its receiver for BRB repetition time (BRBcount−2)×(T_{BRB}+T_{LIFS}). Also, a current value of BC is stored, and a BC timer is stopped and enters into a wait state. After the (BRBcount−2)×(T_{BRB}+T_{LIFS}) elapses, the terminal activates its receiver so as to change its radio operation mode into a listening mode, receives the last BRB, and identifies the last 6 bits symbol of the PHR. This value indicates a length of PHY Service Data Unit (PSDU) which will be received after T_{LIFS} elapses from a completion time of the BRB repetitions. After the time indicated by the above value, the terminal resumes the stopped BC timer. That is, the BC timer restarts decreasing.

2) A Case when the Type of Received Frame is a LESD Response Command Frame.

If the type of the received frame is a LESD response command frame, the physical layer of the terminal receives the PSDU after the currently received BRB, and notifies to the MAC layer that the LESD response command frame is received by using a primitive. The MAC layer identifies a ServiceID parameter of the received LESD response command, and compares the ServiceID parameter with its macServiceID. If the value of the ServiceID parameter matches the macServiceID, the MAC layer updates its to macCommunicationChannelID with a value of CommunicationChannelID of the received frame. Then, the MAC layer removes a command frame waiting in a transmission queue, stops the ongoing CSMA-CA, and notifies to a higher layer that the LESD response command is received by using a MLESD-LESD.confirm primitive.

Otherwise, if the value of the ServiceID parameter does not match to the macServiceID, the MAC layer declares that the processes on the received BRB are completed. Then, the MAC layer resumes the stopped BC timer. That is, the BC timer restarts decreasing.

3) a Case when the Type of Received Frame is a LESD Notification Command Frame.

If the type of the received frame is a LESD notification command frame, the physical layer of the terminal receives the PSDU after the currently received BRB, and notifies to the MAC layer that the LESD notification command frame is received by using a primitive.

The MAC layer identifies a ServiceID parameter of the received LESD notification command, and compares the ServiceID parameter with its macServiceID. If the value of the ServiceID parameter matches the macServiceID, the MAC layer updates its macCommunicationChannelID with a value of CommunicationChannelID of the received frame.

Then, the MAC layer removes a command frame waiting in a transmission queue, stops the ongoing CSMA-CA, and notifies to a higher layer that the LESD notification command is received by using a MLESD-LESD-NOTIFY.indication primitive.

Otherwise, if the value of the ServiceID parameter does not match the macServiceID, the MAC layer declares that the processes on the received BRB are completed. Then, the MAC layer resumes the stopped BC timer. That is, the BC timer restarts decreasing.

A Method for Frame Transmission Using a Parallel CSMA-CA

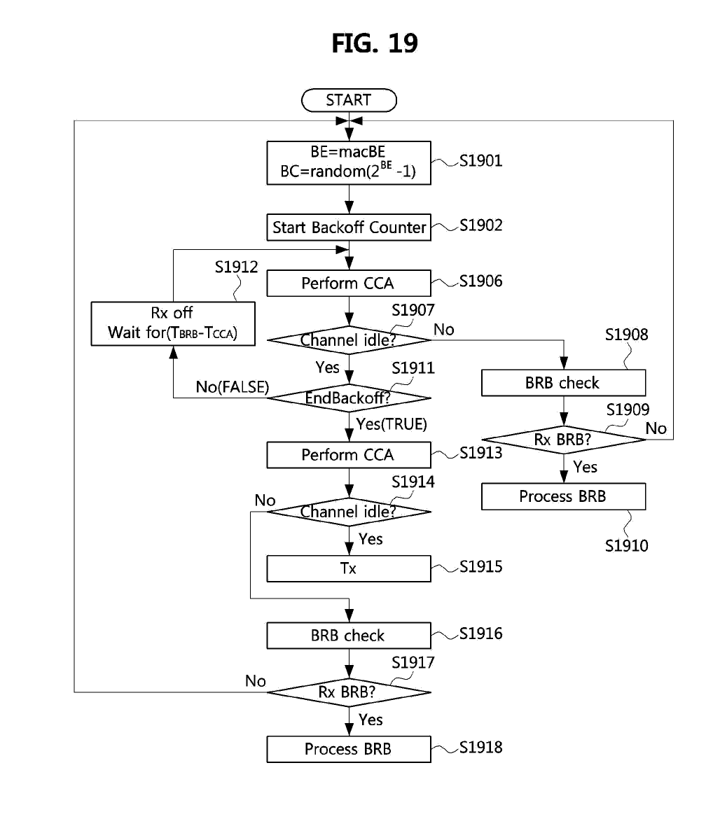

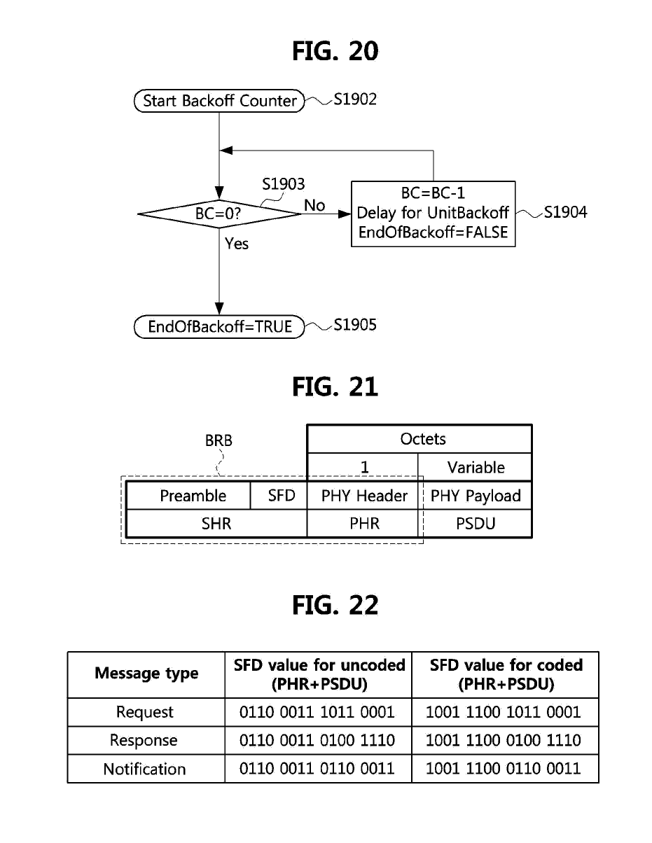

FIG. 19 is a flow chart illustrating a parallel CSMA-CA procedure for Low Energy Service Discovery. FIG. 20 is a flow chart illustrating a backoff count procedure performed in a parallel CSMA-CA procedure illustrated in FIG. 19.

Referring to FIG. 19 and FIG. 20, a terminal may update a value of backoff exponent (BE) with the MAC PIB attribute macBE, and configure a backoff count (BC) by selecting an integer value among 0 to 2^{BE-1} with a uniform probability (S1901).

Then, the terminal start a backoff count procedure illustrated in FIG. 20. In the backoff count procedure, the terminal configures a timer expiring after a time of UnitBackOff, and checks the value of BC every time when the timer expires (S1903). If the value of BC is not 0, the terminal decreases BC by 1, sets EndOfBackoff to FALSE, waits for UnitBackOff (S1904), and checks the value of BC again. Otherwise, if the BC is 0, the terminal sets EndOfBackoff to TRUE (S1905), and exits from the backoff count procedure.

Meanwhile, separately from the above-described backoff count procedure, the terminal changes its radio operation mode into a listening mode, and performs a CCA procedure at the same time (S1906). The terminal may obtain channel samples on a symbol duration of predetermined bits (for example, 8 bits) in the CCA procedure, calculate an average value of the obtained channel samples, and compare the average value with a preconfigured threshold value (CCAThreshold) so as to determine a status of the channel (that is, busy or idle) (S1907). Here, the terminal determines that the channel is in busy state when the average value is greater than the threshold value. Otherwise, the terminal determines that the channel is in idle state.

If the channel is determined to be in busy state, the terminal performs a BRB check procedure for at most 2×T_{BRB}−T_{CCA} (S1908). The terminal checks the receipt of a BRB (S1909), and performs a BRB handling procedure when a BRB is received (S1910). The BRB handling procedure is identical to the above described one. Otherwise, if a BRB is not received during the above time duration, the terminal performs the CSMA-CA procedure again from the step S1901.

Otherwise, if the channel state is determined to be in idle state at the step S1907, the terminal identifies whether the value of EndOfBackoff is set to TRUE (S1911).

If the EndOfBackoff is not set to TRUE in the step S1911, the terminal turns off its receiver, waits for (T_{BRB}−T_{CCA}) (S1912), and resume the CCA procedure. Otherwise, if the EndOfBackoff is set to TRUE in the step S1911, the terminal sets its radio operation mode to listening mode, and performs the CCA procedure (S1913).

Then, the terminal checks a status of the channel (that is, CCA result) (S1914). If the channel is in idle state, the terminal sets its radio operation mode to transmission mode, and transmits a frame in standby state via the channel (S1915).

Otherwise, if the channel is in busy state at the step S1914, the terminal perform a BRB check procedure during at most 2×T_{BRB}−T_{CCA} (S1916). While performing the BRB check procedure, radio operation mode is set to the listening mode.

The terminal checks the receipt of a BRB during the above time (S1917), and performs a BRB handling procedure when a BRB is received (S1918). Otherwise, if a BRB is not received during the above time duration, the terminal performs the CSMA-CA procedure again from the step S1901.

Hereinafter, the physical layer technologies for LESD will be explained.

FIG. 21 illustrates a structure of a physical layer frame.

The physical layer frame may comprise a synchronization header (SHR), a physical layer header (PHR), and a physical layer service data unit (PSDU). Here, the SHR and the PHR correspond to a BRB.

A preamble may be configured repetitions of a specific bit sequence (for example, ‘01010101’).

A SFD is used for indicating a start of a frame, and may have different values according to type of the frame.

FIG. 22 illustrates an example of a SFD used in the LESD.

As shown in FIG. 22, the terminal can identify the type of physical frame based on the SFD. The SFD may have different values for a Request, a Response, a Notification and a No PSDU frame. Thus, if the terminal uses an overhearing technique, the terminal can selectively receive the necessary type of frames. Here, the No PSDU frame is a frame having no PSDU, and used for transmitting only BRBs.

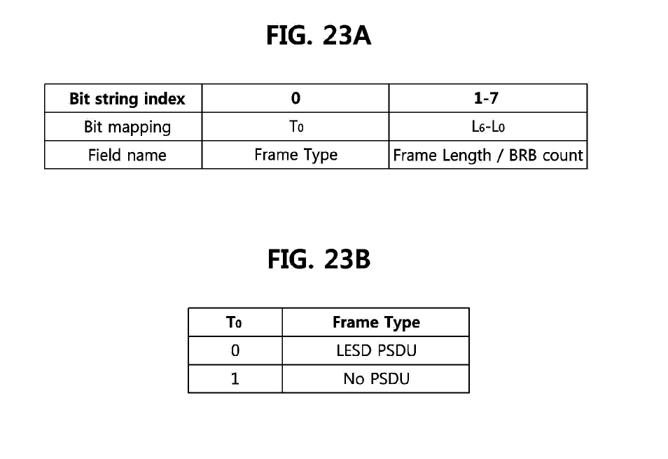

FIG. 23A and FIG. 23B illustrate physical layer headers.

The physical layer header (PHR) may be configured with 1 octet, a first bit (T₀) indicates the type of frame, and the rest of bits (L₆-L₀) indicate a length of the frame or the number of BRBs (BRBCount).

That is, if the type of frame is one of Request, Response, and Notification, the rest of bits may indicate a length of the frame. If the type of frame is a No PSDU frame, the rest of bits may indicate the number of BRB repetitions (that is, BRBCount).

For example, if the first bit is ‘0’, the frame type is a LESD PSDU frame (a frame having PSDU), and the rest of PHR indicates the length of the frame. Otherwise, if the first bit is ‘1’, the frame type is a No PSDU frame, and the rest of PHR indicates BRBCount.

In case of the No PDSU frame, the terminal may receive the BRBs according to the number of the rest BRB repetitions identified by the BRBCount. Thus, it is not necessary to receive BRBs unnecessarily until a preconfigured final time.

While the example embodiments of the present invention and their advantages have been described in detail, it should be understood that various changes, substitutions and alterations may be made herein without departing from the scope of the invention.

What is claimed is:

1. A method for service discovery, performed in a terminal, the method comprising:
performing, by a MAC layer, a passive scan for searching a specific service based on whether to receive a frame including a desired service identifier corresponding to the specific service; and
when it fails to search the specific service, performing, by the MAC layer, an active scan which broadcasts a service discovery request command frame for searching the specific service.

2. The method of claim 1, wherein the performing the passive scan includes:
receiving, by the MAC layer, a scan request primitive including the desired service identifier;
updating, by the MAC layer, a service identifier of the MAC layer based on the desired service identifier of the higher layer;
when a service discovery response command frame or a service discovery notification command frame is received from a physical layer, comparing, by the MAC layer, a service identifier included in the service discovery response command frame or the service discovery notification command frame with the service identifier of the MAC layer; and
when the service identifier included in the service discovery response command frame or the service discovery notification command frame matches the service identifier of the MAC layer, reporting, by the MAC layer, to the higher layer that the service discovery response command frame or the service discovery notification command frame is received.

3. The method of claim 1, wherein the MAC layer performs the passive scan for a time duration determined based a time needed for receiving a single basic repetition block (BRB) and a repetition number of the BRBs.

4. The method of claim 1, wherein the performing the passive scan further includes: transmitting, by the MAC layer, a result of the passive scan to a higher layer by using a scan confirm primitive.

5. The method of claim 1, further comprising:
when it is successful to search the specific service through the passive scan, accessing a Personal Area Network (PAN) providing the specific service; and
performing a channel sampling (CS) procedure while trying to access the PAN.

6. The method of claim 2, wherein the performing the active scan includes:
receiving, by the MAC layer, a service discovery request primitive instructing to perform the active scan from a higher layer;
generating, by the MAC layer, a service discovery request command frame in response to the service discovery request primitive, and broadcasting the service discovery request command frame;
if the MAC layer receives a service discovery response command frame from another terminal for a predetermined standby time, comparing a service identifier included in the service discovery response command frame with the service identifier of the MAC layer; and
when the service identifier included in the service discovery response command frame matches the service identifier of the MAC layer, transmitting, by the MAC layer, a service discovery confirm primitive notifying that the service discovery response command frame is received to the higher layer.

7. The method of claim 6, wherein the transmitting the service discovery confirm primitive includes: generating, by the MAC layer, a service discovery notification command frame, and broadcasting the service discovery notification command frame.

8. The method of claim 6, wherein, in the performing the active scan, when the service identifier included in the service discovery response command frame matches the service identifier of the MAC layer, a service discovery request command frame in standby status for service discovery is not transmitted.

9. The method of claim 6, further comprising:
if the MAC layer does not receive a service discovery response command frame from another terminal for the predetermined standby time, broadcasting the service discovery request command frame repetitively until a retransmission number does not exceed a maximum retransmission number; and
if the service discovery response command frame is not received until the retransmission number exceeds the maximum retransmission number; transmitting a primitive notifying that the active scan fails to the higher layer.

10. The method of claim 1, further comprising:
if the active scan fails to search the specific service, performing a channel sampling in which the MAC layer activates a receiver of the terminal only for a channel sampling duration configured with a predetermined channel sampling periodicity and monitors a receipt of a service discovery request command frame by using the activated receiver.

11. The method of claim 10, wherein the performing the channel sampling includes:
receiving, by the MAC layer, a channel sampling request primitive instructing to perform the channel sampling from the higher layer;
updating, by the MAC layer, a value of repetition number of the BRBs and a value of channel sampling duration of the MAC layer with a parameter value on repetition number of the BRBs and a parameter value on the channel sampling duration included in the channel sampling request primitive; and
monitoring, by the MAC layer, a receipt of the service discovery request command frame for the channel sampling duration.

12. The method of claim 11, wherein the performing the channel sampling further includes:
if the service discovery request command frame is not received for the channel sampling duration, inactivating, by the MAC layer, the receiver of the terminal, and waiting until a next channel sampling duration.

13. The method of claim 11, wherein the performing the channel sampling further includes:
if the service discovery request command frame is received for the channel sampling duration, comparing a service identifier included in the service discovery request command frame with the service identifier of the MAC layer; and
if the service identifier included in the service discovery request command frame matches to the service identifier of the MAC layer, transmitting a service discovery indication primitive notifying that the service discovery request command frame is received to the higher layer.

14. The method of claim 13, wherein the performing the channel sampling further includes:
receiving, by the MAC layer, a service discovery response primitive in response to the service discovery indication primitive from the higher layer; and
generating, by the MAC layer, a service discovery response command frame, and broadcasting the generated service discovery response frame.

15. A method for service discovery, performed in a terminal, the method comprising:
receiving a service discovery request frame from another terminal;
when a service identifier included in the service discovery request frame matches a service identifier of a MAC layer of the terminal, transmitting, by the MAC layer, a service discovery indication primitive notifying that the service discovery request frame is received to a higher layer;
receiving, by the MAC layer, a service discovery response primitive from the higher layer; and
generating, by the MAC layer, a service discovery response command frame based on the service discovery response primitive, and broadcasting the service discovery response command frame.

16. The method of claim 15, further comprising:
receiving a service discovery notification command frame from another terminal after the broadcasting the service discovery response command frame; and
if a service identifier included in the service discovery notification command frame matches the service identifier of the MAC layer, transmitting, by the MAC layer, a notify indication primitive notifying that the service discovery notification command frame is received to the higher layer.

17. A method for service discovery, performed in a terminal, the method comprising:
performing a passive scan for searching a specific service based on whether to receive a frame including a desired service identifier corresponding to the specific service in a MAC layer of the terminal; and
when it is successful to search the specific service, performing a channel sampling in which the MAC layer activates a receiver of the terminal only for a channel sampling duration configured with a predetermined channel sampling periodicity and monitors a receipt of a service discovery request command frame by using the activated receiver.

18. A method for service discovery, performed in a terminal, the method comprising:
configuring a value of backoff count;
performing a clear channel assessment (CCA);
when a channel is in busy state, checking a receipt of a basic repetition block (BRB) for a first time duration; and
if the BRB is received for the first time duration, identifying type of a received frame based on information included in the BRB, and processing BRBs after the BRB according to the type of the received frame.

19. The method of claim 18, wherein the identifying type of the received frame and the processing BRBs include:
identifying the type of the received frame based on a Start Frame Delimiter (SFD) of the BRB;
when the received frame is a service discovery request frame, inactivating a receiver of the terminal for a time duration determined based on a BRB repetition number indicated by a header of the received frame, activating the receiver after the time duration expires, and decreasing the backoff count;
when the received frame is a service discovery response frame, if a service identifier included in the service discovery response frame matches a service identifier of a MAC layer of the terminal, removing a frame in a standby status for transmission; and
when the received frame is a service discovery notification frame, if a service identifier included in the service discovery notification frame matches the service identifier of the MAC layer of the terminal, updating a communication channel identifier of the MAC layer with a communication channel identifier included in the service discovery notification frame, and removing a frame in a standby status for transmission.

20. The method of claim 18, further comprising:
decreasing the backoff count until the backoff count reaches a preconfigured value, and performing a backoff count procedure in which the terminal waits with a receiver of the terminal inactivated for a predetermined unit backoff time every time when the backoff count decreases.
